(19) United States
(12) Patent Application Publication
(10) Pub. No.: US 2007/0137161 A1
(43) Pub. Date: Jun. 21, 2007

(54) Disposable magnetic bedknife

(75) Inventors: Jonathan Dohme F. Mahan, Charlotte, NC (US); James Berkeley, Pineville, NC (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/635,588

(22) Filed: Dec. 8, 2006

Related U.S. Application Data
(63) Continuation of application No. 11/116,765, filed on Apr. 28, 2005, now abandoned.
(60) Provisional application No. 60/568,124, filed on May 4, 2004.

(51) Int. Cl. A01D 34/53

(52) U.S. Cl. 56/249

(57) ABSTRACT

A reel mower assembly which includes a mower reel mounted to a frame, a drive operative to rotate the reel about a reel axis, a magnetic backing plate mounted to the frame and a magnetic bed bar retained in proximity to the backing plate in an operating position. The assembly includes a bed knife interposed between the backing plate and the bed bar, with the backing plate providing additional magnetic attraction between the bed bar and bed knife. The assembly includes an engagement device for preventing sliding movement of the bed knife with respect to the bed bar while allowing the bed knife to move away from the bed bar and backing plate when a separating force is exerted on the bed knife in a direction away from the bed bar that is greater than an attractive force exerted on the bed knife by the bed bar.

### CROSS-REFERENCE TO RELATED APPLICATION(s)

This application is a continuation of and claims domestic priority benefits under 35 U.S.C. §120 to U.S. patent application Ser. No. 11/116,765, the entire contents of which are hereby incorporated by reference herein.

### FIELD OF THE INVENTION

The present invention relates to a reel mower, and more particularly, to a disposable magnetic bed knife for a reel mower.

### BACKGROUND OF THE INVENTION

Reel mowers use a scissoring action, rather than a tearing action, to shear grass and like foliage. Such reel mowers typically provide a high quality cut, but require more maintenance than rotary mowers. Golf course superintendents prefer such mowers where appearance and healthy grass are important, such as on golf greens.

In a typical reel mower assembly, an attachment member, commonly called a bed bar or backer, attaches to the apparatus in rigid relationship to the reel, and a replaceable bed knife attaches to the bed bar. The bed knife is maintained parallel to the reel axis and in close proximity to the reel knives so that the reel and the bed knives achieve a quality sheering action. Typically, an adjustment mechanism allows movement of the bed bar relative to the reel so that the bed knife can be moved into proper relationship with the rotating reel.

Conventionally, the bed knife attaches to the bed bar with a plurality of screws placed through holes in the bed knife, and by further engaging threaded holes in the bed bar. Such conventional arrangements typically use ten or more screws to attach the bed knife to the bed bar. Thus, replacing the bed knife requires removing the screws, changing the bed knife, and screwing the new bed knife to the bed bar. Typically, the bed knife attaches to the underside of the bed bar so that the mower must be sufficiently raised or partially disassembled to access the underside of the reel mower assembly to remove the screws and the bed knife. A reel mower unit used in a typical golf course application may use multiple reel mower assemblies. Changing bed knives on a reel mower, especially a mower with multiple reels, requires significant manual labor time and corresponding downtime.

When the bed knife is screwed to the bed bar, stones or similar debris entering the mower can jam between the fixed bed knife and the reel, damaging one or more portions of the reel mower assembly. Bed knives may also sustain damage when contacting a substantially buried obstruction. Damage to the bed knife can be quite costly and problematic, given the close tolerances required for proper operation. Furthermore, a bed knife tends to dull the more often it is used. Grinding a new cutting edge onto a bed knife also requires time and expertise, thereby increasing maintenance costs.

### SUMMARY OF THE INVENTION

An example embodiment is directed to a reel mower assembly comprising a mower reel rotatably mounted to the frame and a drive operative to rotate the reel about a reel axis. The reel mower assembly includes a magnetic backing plate mounted to the frame, a magnetic bed bar retained in proximity to the backing plate in an operating position, and a bed knife interposed between the backing plate and the bed bar so that the bed knife is oriented in cutting relationship with the reel. The backing plate provides additional magnetic attraction between the bed bar and bed knife to prevent the bed knife from disconnecting from the bed bar. The reel mower assembly also includes an engagement device operative to prevent sliding movement of the bed knife with respect to the bed bar while allowing the bed knife to move away from the bed bar and backing plate to disconnect the bed knife from the bed bar and prevent damage to the reel mower assembly when a separating force is exerted on the bed knife in a direction away from the bed bar that is greater than an attractive force exerted on the bed knife by the bed bar when the bed bar is in the operating position.

Another example embodiment is directed to a reel mower assembly comprising a frame, a primary mover attached to the frame for displacing the mower, a power source supported by the frame for operating the primary mover, a mower reel rotatably mounted to the frame and a drive operative to rotate the reel about a reel axis. The reel mower assembly includes a magnetic backing plate mounted to the frame, a magnetic bed bar retained in proximity to the backing plate in an operating position, and a bed knife interposed between the backing plate and the bed bar so that the bed knife is oriented in cutting relationship with the reel. The backing plate provides additional magnetic attraction between the bed bar and bed knife to prevent the bed knife from disconnecting from the bed bar.

Further areas of applicability of the present invention will become apparent from the detailed description provided hereinafter. It should be understood that the detailed description and specific examples, while indicating example embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded perspective view of a walk-behind reel mower arranged in accordance with the teachings of the present invention.

FIG. 2 is an exploded perspective view of a reel mower assembly constructed in accordance with the teachings of the present invention.

FIG. 3 is a perspective view of the top of a magnetic bed bar of one embodiment of the present invention.

FIG. 4 is a perspective view of the underside of the bed bar in FIG. 3.

FIG. 5 is a perspective view of a bed knife for attachment to the magnetic bed bar of FIG. 3.

FIG. 6 is a schematic view of the bed knife of FIG. 5 in the operating position on the magnetic bed bar of FIG. 3.

FIG. 7 is a schematic view of an alternative bed knife in the operating position on the magnetic bed bar of FIG. 3.

FIG. 8 is a plan view of a bed knife according to a first method of manufacture.

FIG. 9 is a cross sectional view of the bed knife of FIG. 8.

FIG. 10 is a plan view of the blank used in forming the bed knife of FIG. 8.

FIG. 11 is a plan view of the bed knife of FIG. 8 following multiple grinding operations;

FIG. 12 is a cross sectional view of the bed knife of FIG. 11.

FIG. 13 is a plan view of the bed knife of FIG. 11 following the final grinding operation.

FIG. 14 is a cross sectional view of the bed knife of FIG. 13.

FIG. 15 is a plan view of a bed knife according to a second method of manufacture.

FIG. 16 is a cross sectional view of the bed knife of FIG. 15.

### DETAILED DESCRIPTION OF THE EXAMPLE EMBODIMENTS

The following description of example embodiments is merely exemplary in nature and is in no way intended to limit the invention, its application, or uses.

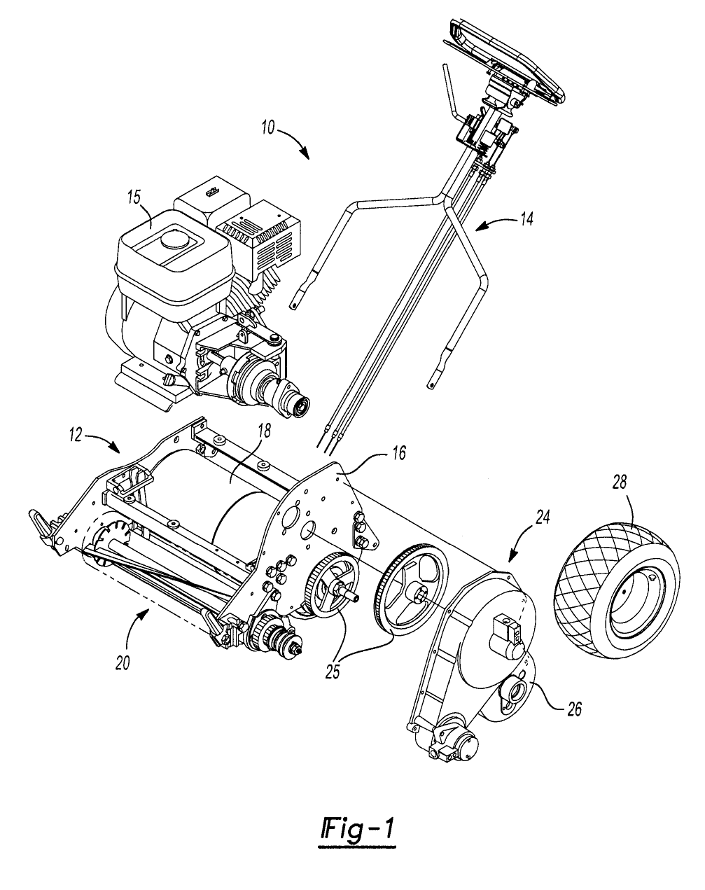

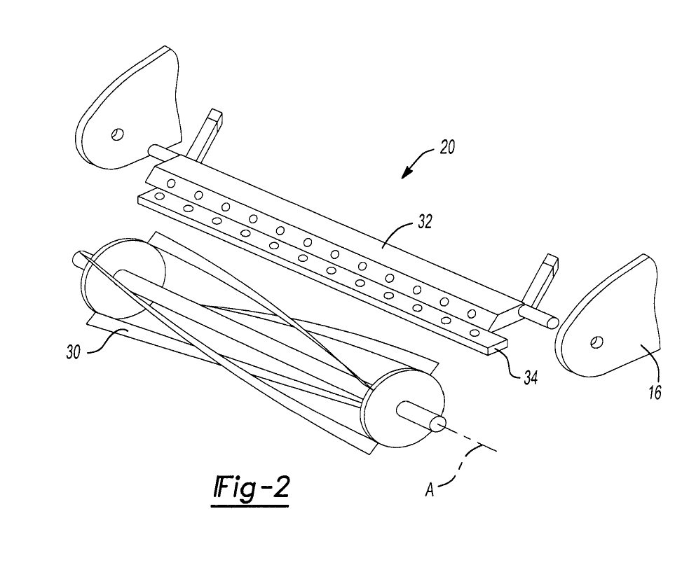

FIG. 1 shows the basic components of a mower 10 constructed in accordance with the present invention. Mower 10 is shown as a walk-behind mower; however, mower 10 can be any variety of reel-type greens mower, including single and multiple reel-type mowing devices. Mower 10 includes cutting unit 12, which comprises a power source or engine 15 coupled to a frame 16, and a handle 14 coupled to frame 16. A traction roller 18 is rotatably coupled to frame 16 and drivingly connected to engine 15. Cutting unit 12 further includes a reel mower assembly 20, described in detail with respect to FIGS. 2-5. A transmission 24 includes a plurality of sprockets 25 selectively transferring rotational output torque of engine 15 to traction roller 18. Transmission 24 includes a clutch 26 positioned intermediate engine 15 and transmission 24. Clutch 26 operates in an engaged and disengaged mode for selectively transferring power from engine 15 to traction roller 18. Wheels 28 are coupled to traction roller 18 and are also selectively driven by engine 15 to provide motive force for translating walk-behind greens mower 10, typically during a transportation mode of operation.

FIG. 2 schematically illustrates the major parts of reel mower assembly 20. Reel mower assembly 20 comprising a mower reel 30 mounted to frame 16 to enable relative rotational movement. Reel mower assembly 20 is commonly found on various types of mowers, including riding mowers and walk-behind mowers. A drive rotates reel 30 about a reel axis A. A magnetic bed bar 32 attaches to frame 16, and bed knife 34 magnetically attaches to magnetic bed bar 32. Typically, reel 30 further includes an adjustment mechanism to vary the position of magnetic bed bar 32 with respect to reel 30 in order to provide the proper cutting relationship between bed knife 34 and mower reel 30.

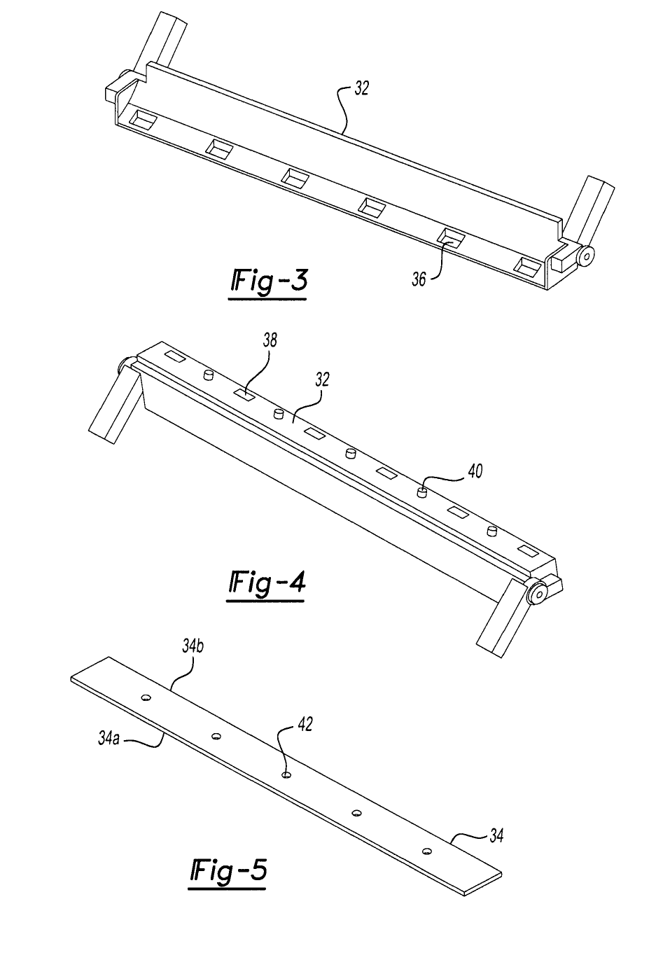

FIGS. 3 and 4 show an embodiment of magnetic bed bar 32 in accordance with the present invention. Magnetic bed bar 32 includes a plurality of magnets 36. Magnets 36 are embedded into magnetic bed bar 32 providing a substantially flush surface 38 for connecting bed knife 34. Bed knife 34 is magnetically maintained against magnets 36 in an operating position through the use of locating pins 40.

FIG. 5 illustrates a bed knife 34 constructed in accordance with the present invention. Bed knife 34 includes a first cutting edge 34A and a second cutting edge 34B. Cutting edges 34A and 34B are formed on opposite sides of bed knife 34, allowing only one cutting edge 34A to be in operation at any time. As cutting edge 34A dulls, bed knife 34 can be reversed operationally orient the other cutting edge 34B. After both cutting edges 34A and 34B are dulled, bed knife 34 may be removed, discarded, and replaced. Bed knife 34 also includes apertures or notches 42 for engaging locating pins 40 of magnetic bed bar 32. While locating pins 40 and notches 42 are properly aligned, bed knife 34 is not able to slide out of position relative to magnetic bed bar 32.

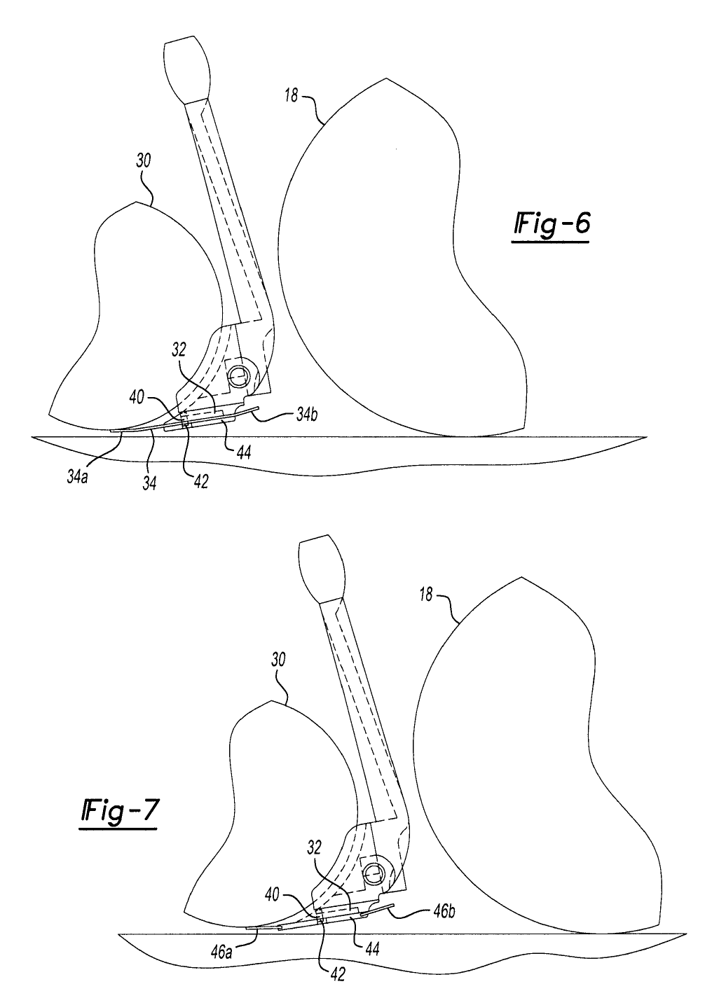

FIG. 6 shows a first embodiment of the magnetic bed knife assembly. Bed knife 34 magnetically attaches to magnetic bed bar 32. Locating pins 40 of bed bar 32 engage notches 42 of bed knife 34 and magnetic backing plate 44 to ensure the proper cutting relationship between bed knife 34 and reel 30. Magnetic backing plate 44 provides additional magnetic attraction between magnetic bed bar 32 and bed knife 34 to prevent bed knife 34 from disconnecting from bed bar 32.

In certain applications, selection of the magnetic backing plate 44 may impact the operation of reel mower assembly 20. Depending on the length and thickness of the grass, different strength magnetic backing plates 44 may be needed. For example, a weaker magnetic backing plate 44 could be used for cutting the green on a golf course when the grass is shorter and damage to reel mower assembly 20 is less likely. Cutting thick grass may require extra magnetic force to prevent bed knife 34 from disconnecting from magnetic bed bar 32. This requires a stronger magnetic backing plate 44. Although additional magnetic force is provided by magnetic backing plate 44, the magnetic force still allows bed knife 34 to disconnect from magnetic bed bar 32 to prevent damage to reel mower assembly 20. Magnetic backing plate 44 may be formed from steel, and bed knife 34 is formed from a more flexible material, such as tempered spring steel.

As depicted in FIG. 6, bed knife 34 may be formed from one piece of a material. Alternatively, FIG. 7 shows a second configuration of the bed knife assembly in accordance with the present invention. FIG. 7 includes a magnetic bed bar 32 magnetically attached to magnetic backing plate 44. Locating pins 40 of magnetic bed bar 32 engage notches 42 formed on magnetic backing plate 44. This engagement ensures that bed knives 46A and 46B are in proper cutting relationship to reel 30. In the second configuration, a pair of bed knives 46A and 46B is bonded to opposite ends of backing plate 44. Securing bed knives 46A and 46B to the magnetic backing plate 44 could be any bonding method, such as gluing or staking.

As previously stated, first and second bed knives 46A and 46B are bonded to magnetic backing plate 44. Only one bed knife 46A is necessary, however, if first bed knife 46A dulls, magnetic backing plate 44 can be reversed to operationally orient second bed knife 46B to provide a cutting edge. Magnetic backing plate 44 may be formed from steel, and first and second bed knives 46A and 46B are formed from a more flexible material, such as tempered spring steel.

The present invention could be practiced in a number of fashions including by manufacturing new reel cutting assemblies in accordance with the present invention, or alternatively, by producing a retrofit bed bar or support frame kit which would allow the magnetic blade attachment of the present invention to be implemented on an existing mower.

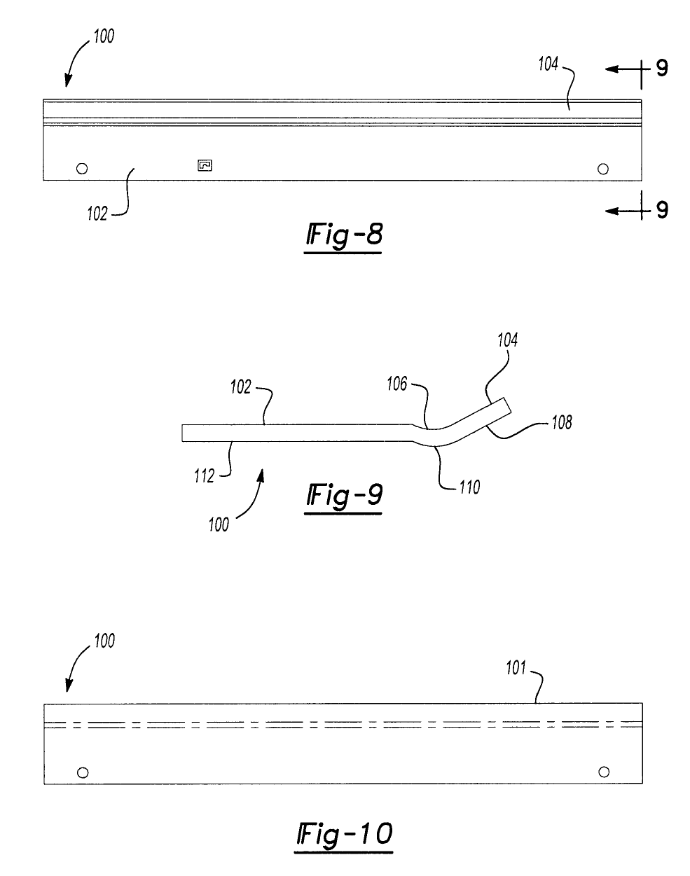

Additionally, magnetic bed knife 34 of the present invention could be manufactured according to various manufacturing processes. More particularly, as seen in FIGS. 8-14, bed knife 34 may be made of carbon steel, specifically AISI 1566 Hot Rolled Pickled and Oiled steel, which is generally referenced at numeral 100. Carbon steel bed knife 100, like bed knife 34, is adapted to be magnetically held against magnets 36 in an operating position on bed bar 20 as illustrated in FIG. 6 such that bed knife 100 is oriented in cutting relationship with reel 30 in the same fashion as bed knife 34.

With particular reference to FIGS. 8-14, the manufacturing steps of carbon steel bed knife 100 will now be discussed in detail. A generally planar blank 101 is first cut to length. Planar blank 101 is then fed through a stamping or pressing machine that first flattens and straightens planar blank 101 and then imparts a bending force upon the blank. Although this shape can vary among reel mowers, the present shape of bed knife 100 includes a generally planar mounting portion 102 and an upturned cutting portion 104. As best seen in FIG. 9, upturned cutting portion 104 initially includes a radius portion 106 interconnecting a distal end 108 with mounting portion 102. Specifically, as a result of the stamping process used to form carbon steel, radius portion 106 includes an outer surface 110 that, as seen in FIG. 9, extends below a lower surface 112 of mounting portion 102. As should be appreciated by one skilled in the art, this condition of outer surface 110 extending below lower surface 112 is undesirable as it may impede proper turf cutting and/or may contact the ground surface. Furthermore, this condition may further limit the reel mower's minimum cutting height. Accordingly, it is preferable to grind off this outer surface 110 to define a generally unobstructed lower surface.

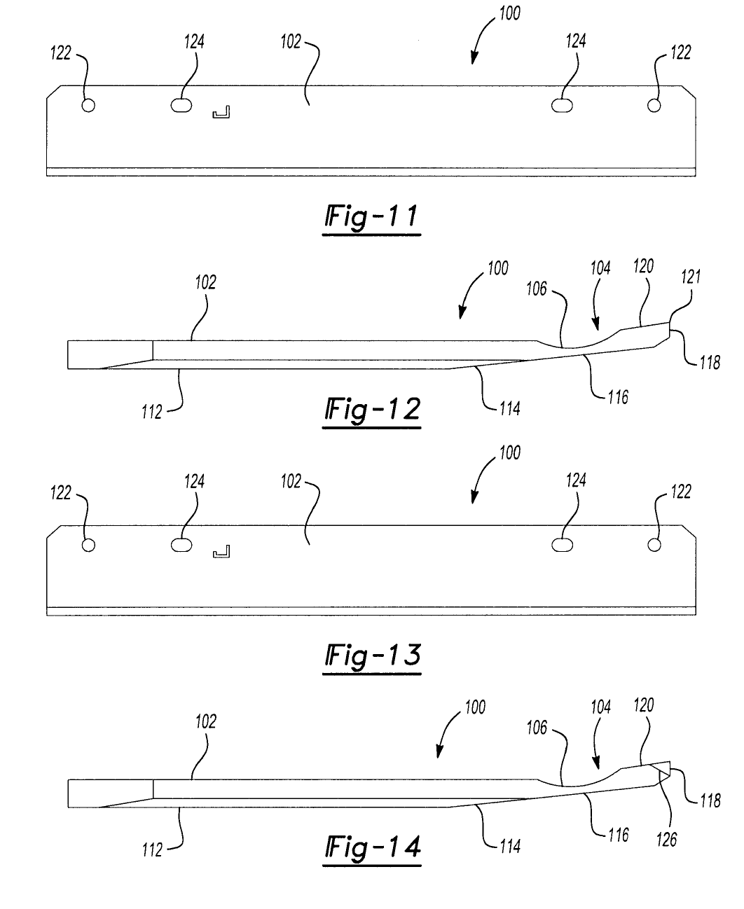

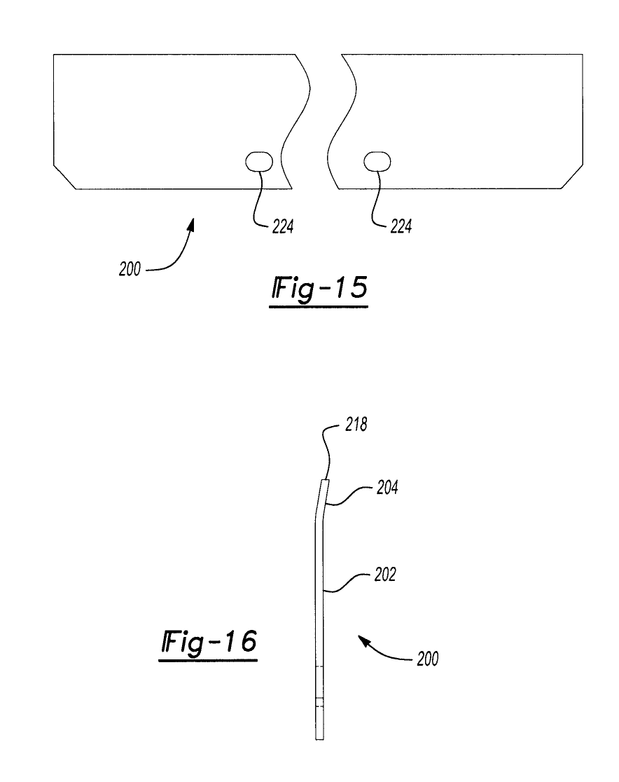

As best seen in FIGS. 11 and 12, bed knife 100 is illustrated following completion of a series of grinding operations sufficient to remove outer surface 110 and define a plurality of faces to create a final desired shape. Specifically, as seen in FIG. 12, bed knife 100 includes a tournament cut face 114 extending upwardly from lower surface 112 of mounting portion 102. Preferably, tournament cut face 114 extends upwardly from lower surface 112 at a relative angle of about 5 degrees. Tournament cut face 114 transitions into a super tournament cut face 116 that extends further upwardly at a greater inclination of about 8 degrees relative to lower surface 112. Bed knife 100 includes a front face 118, which is at about 90 degrees relative to lower surface 112, and a top face 120, which is at about 8 to 10 degrees relative to lower surface 112. Front face 118 and top face 120 intersecting at an edge 121. Tournament cut face 114, super tournament cut face 116, front face 118, and top face 120 are each formed through various grinding operations that requires bed knife 100 to be fed through a milling machine. Following these grinding operations, bed knife 100 is then heat-treated to provide sufficient hardness to reduce the wear of bed knife 100 during operation.

Referring now to FIG. 11, following heat treatment, bed knife 100 further includes a pair of apertures 122 formed through mounting portion 102. This pair of apertures 122 is used during manufacturing to position bed knife 100 during subsequent grinding operations. Additionally, a second pair of apertures 124 is formed through mounting portion 102. This second pair of apertures 124 is sized, similar to apertures or notches 42, to receive locating pins 40 of magnetic bed bar 32.

Finally, as seen in FIGS. 13 and 14, a final grind of bed knife 100 is completed. Specifically, through a subsequent grinding operation, following heat treatment, top face 120 is finish ground down such that it is about 5.5 degrees inclined relative to lower surface 112. Similarly, front face 118 is ground down to create a cutting edge 126 in place of edge 121. The particular inclination of cutting edge 126 is dependent upon the desired cutting configuration relative to reel 30.

Although bed knife 100 provides a number of beneficial cutting properties and prolonged wear, the manufacturing thereof may lead to undesirably high costs and complexity. Therefore, a second embodiment of the present invention provides a preferred method of manufacturing the bed knife which is capable of eliminating many of the grinding steps, heat treatment, and complexity of construction.

With particular reference to FIGS. 16 and 17, a bed knife 200 is illustrated being manufactured from a simplified process. More particularly, bed knife 200 is made of spring steel, specifically C1095 Scaleless Blue-Tempered Spring Steel, ASTM A682, which is hardened to a minimum Rockwell number of about 47C. Spring steel bed knife 200, like bed knifes 34 and 100, is adapted to be magnetically held against magnets 20 in an operating position on bed bar 32 as illustrated in FIG. 6 such that bed knife 200 is oriented in cutting relationship with reel 30 in the same fashion as bed knife 34.

Still referring to FIGS. 16 and 17, the manufacturing steps of spring steel bed knife 200 will now be discussed in detail. As will be appreciated, the manufacturing steps of spring steel bed knife 200 are dramatically simplified relative to bed knife 100, thereby leading to reduced manufacturing complexity and cost. A generally planar blank (not shown) is fed into a cold roll-forming machine that imparts a bending force upon the blank. Preferably, the planar blank is a roll of spring steel that can quickly and easily be shaped in a continuous, uninterrupted process. As best seen in FIGS. 16 and 17, the blank is shaped through a series of rollers into a desired shape. Due to the nature of spring steel, this shaping process may require one or more bending and over bending operations to produce the desired final shape.

Although the final shape can vary among reel mower designs, the present shape of bed knife 200 includes a generally planar mounting portion 202 and an upturned cutting portion 204. As best seen in FIG. 17, upturned cutting portion 204 extends upwardly from mounting portion 202 at a relative angle of about 9 degrees. As can be appreciated from the figures, unlike bed knife 100 that includes downwardly protruding outer surface 110 of radius portion 106 caused during the stamping process, the cold roll forming process of the present embodiment does not create such effect, thereby eliminating the need to grind tournament cut face 114 and super tournament cut face 116. Therefore, the use of spring steel permits the use of roll forming rather than stamping, which eliminates a number of grinding operations, but for a final grind of front face 218 to define a cutting surface.

As seen in FIG. 16, bed knife 200 further includes a pair of apertures 224 are formed through mounting portion 202. This pair of apertures 224 is sized, similar to apertures or notices 42, to receive locating pins 40 of bed bar 32.

Spring steel bed knife 200 provides a number of advantages over conventional screw-on bed knives and, even, bed knife 100. Specifically, bed knife 200, being made of spring steel, enables it to be made according to a simple cold roll forming technique. This technique, which has not been used before to form magnetic bed knives, dramatically simplifies the manufacturing process, thereby eliminating the need for complex flattening, straightening, forming, grinding, and heat-treating operations.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A reel mower assembly, comprising:
a mower reel rotatably mounted to a frame;
a drive operative to rotate the reel about a reel axis;
a magnetic backing plate mounted to the frame;
a magnetic bed bar retained in proximity to the backing plate in an operating position;
a bed knife interposed between the backing plate and the bed bar so that the bed knife is oriented in cutting relationship with the reel, the backing plate providing additional magnetic attraction between the bed bar and bed knife to prevent the bed knife from disconnecting from the bed bar; and
an engagement device operative to prevent sliding movement of the bed knife with respect to the bed bar while allowing the bed knife to move away from the bed bar and backing plate to disconnect the bed knife from the bed bar and prevent damage to the reel mower assembly when a separating force is exerted on the bed knife in a direction away from the bed bar that is greater than an attractive force exerted on the bed knife by the bed bar when the bed bar is in the operating position.

2. The reel mower assembly of claim 1, wherein the engagement device further comprises a plurality of locating members formed on the bed bar.

3. The reel mower assembly of claim 2, wherein the engagement device further comprises a plurality of apertures formed in the bed knife for engaging the locating members.

4. The reel mower assembly of claim 1, wherein the engagement device further comprises a plurality of notches formed in the bed knife and a plurality of locating members formed on the bed bar for engaging the notches and contacting a surface of the backing plate.

5. The reel mower assembly of claim 1, wherein the bed knife has a first side and a second side, each side arranged to provide a cutting function, and wherein the bed knife is reversible so that only one of the first and second sides provides the cutting function at any time.

6. The reel mower assembly of claim 1, wherein the bed knife is formed of a material more flexible than the backing plate.

7. The reel mower assembly of claim 1, wherein the backing plate is formed of steel and the bed knife is formed of tempered spring steel.

8. The reel mower assembly of claim 1, further comprising a walk-behind mower supporting the reel mower assembly.

9. A reel mower assembly, comprising:
a mower reel rotatably mounted to a frame;
a drive operative to rotate the reel about a reel axis;
a magnetic backing plate mounted to the frame, the backing plate having a pair of bed knives, one bed knife attached at each end thereof;
a magnetic bed bar magnetically attached to the backing plate in an operating position; and
an engagement device operative to prevent sliding movement of the backing plate with bed knives with respect to the bed bar while allowing the backing plate with bed knives to move away from the bed bar when a separating force is exerted on the backing plate in a direction away from the bed bar that is greater than an attractive force exerted on the backing plate by the bed bar when the bed bar is in the operating position.

10. The reel mower assembly of claim 9, wherein the engagement device further comprises a plurality of apertures formed in the backing plate for engaging a plurality of locating members on the bed bar to align the bed bar with the backing plate.

11. The reel mower assembly of claim 9, wherein the each of the bed knives has a side providing cutting function that is oriented opposite to one another so that only one of the bed knives is used for cutting at any time, and wherein the backing plate is reversible to orient the other of the bed knives to provide the cutting function.

12. The reel mower assembly of claim 9, wherein each bed knife is tempered spring steel.

13. The reel mower assembly of claim 9, further comprising a walk-behind mower supporting the reel mower assembly.

14. A reel mower assembly, comprising:
a frame;
a primary mover attached to the frame for displacing the mower;
a power source supported by the frame for operating the primary mover;
a mower reel rotatably mounted to the frame;
a drive operative to rotate the reel about a reel axis;
a magnetic backing plate mounted to the frame;
a magnetic bed bar retained in proximity to the backing plate in an operating position; and
a bed knife interposed between the backing plate and the bed bar so that the bed knife is oriented in cutting relationship with the reel, the backing plate providing additional magnetic attraction between the bed bar and bed knife to prevent the bed knife from disconnecting from the bed bar.

15. The reel mower assembly of claim 14, further comprising:
a plurality of locating members formed on the bed bar, and
a plurality of notches formed in the bed knife for receiving the locating members to align the bed knife with the bed bar.

16. The reel mower assembly of claim 14, wherein the bed knife has a first side and a second side, each side arranged to provide a cutting function, and wherein the bed knife is oriented so that only one of the first and second sides provides the cutting function at any time.

17. The reel mower assembly of claim 14, wherein the bed knife is formed of a material more flexible than the backing plate.

18. The reel mower assembly of claim 14, wherein the backing plate is steel and the bed knife is tempered spring steel.

19. The reel mower assembly of claim 14, further comprising a walk-behind mower supporting the reel mower assembly.

20. A reel mower assembly, comprising:
a frame;
a primary mover attached to the frame for displacing the mower;
a power source supported by the frame for operating the primary mover;
a mower reel rotatably mounted to the frame;
a drive operative to rotate the reel about a reel axis;
a magnetic backing plate mounted to the frame, the backing plate having a pair of bed knives, one bed knife attached at each end thereof; and
a magnetic bed bar attached to the backing plate in an operating position.

21. The reel mower assembly of claim 20, further comprising:
a plurality of locating members formed on the bed bar, and
a plurality of notches formed in the backing plate for engaging the locating members to align the bed bar with the backing plate.

22. The reel mower assembly of claim 20, wherein each of the bed knives has a side providing a cutting function, the sides having the cutting function oriented opposite to one another so that only one of the bed knives is used for cutting at any time, and wherein the backing plate is reversible to orient the other of the bed knives to provide the cutting function.

23. The reel mower assembly of claim 20, wherein each bed knife is tempered spring steel.

24. The reel mower assembly of claim 20, further comprising a walk-behind mower supporting the reel mower assembly.
